(19) United States
(12) Patent Application Publication
(10) Pub. No.: US 2009/0222611 A1
(43) Pub. Date: Sep. 3, 2009

(54) Digital input/output unit, controller, engineering system, programmer and display unit, especially for automation and plant engineering

(76) Inventors: Peter Becker, Gaggenau (DE); Wigand Schneiderheinze, Leimersheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/380,312

(22) Filed: Feb. 26, 2009

(30) Foreign Application Priority Data
Feb. 29, 2008 (EP) 08003817.7

(51) Int. Cl. G06F 13/00; G06F 3/048

(52) U.S. Cl. 710/316; 715/763

(57) ABSTRACT

A digital input/output unit has a series of terminal points and visual display devices assigned to the terminal points for the display of the respective switching state. It also has an interface for the exchange of process data with a controller and an electronic circuit connected between the interface and the respective terminal points for converting the process data into corresponding switching signals and vice versa. The electronic circuit has an evaluation device for terminal point related signaling data received from the interface in order to activate a respective selected visual display device regardless of the current switching state. Alternatively, or in addition, the electronic circuit can have an evaluation device for a common signaling datum, which can be received from the interface, relative to the complete input/output unit in order to be able to jointly activate all visual display devices regardless of the particular current switching state.

### CROSS REFERENCE TO RELATED APPLICATIONS

This application claims priority of European Patent application No. 08003817.7 EP filed Feb. 29, 2008, which is incorporated by reference herein in its entirety.

### FIELD OF INVENTION

The invention relates to a digital input/output unit, especially for automation and plant engineering. The input/output unit can be exclusively an input unit, exclusively an output unit or a combined input/output unit. Depending on the type, it has a series of input terminal points and/or a series of output terminal points. Furthermore, the input/output unit preferably has a visual display means, assigned in each case to one of the terminal points, for display of the respective switching state. The visual display means is preferably an LED (light emitting diode). The input/output unit has an interface for the exchange of process data with a controller and an electronic circuit, connected between the interface and the respective terminal points, for the conversion of process data into corresponding switching signals and vice versa.

The invention also relates to a controller, especially a programmable logic controller (PLC), which has a bus interface for a communication bus for the input and output of process data to at least one addressed input/output unit connected to the communication bus. By means of the input/output unit, the process data can be converted into corresponding switching signals at the terminal points of the respective input/output unit and vice versa. The controller furthermore has a test interface for connecting the controller to an engineering system or to a programmer and also a control unit for the acquisition of output-end process data changed in the engineering system or at the user end by means of the programmer, and for the output of the changed output-end data to the respective addressed input/output unit, at least when the controller is in the test mode.

Furthermore, the invention relates to an engineering system for the planning of at least part of a technical plant and/or an automatic system. The engineering system has a display for the graphical output of process data, of logic operations and/or interconnection diagrams of automation components to be interconnected or already interconnected, such as controllers, terminals, machines, input/output units and similar. It also has user input means for the input of user instructions, e.g. a keyboard or a mouse, and planning software, running on a processor of the engineering system, for the conversion of input user instructions, at least for requesting, changing and displaying process data of selected input/output units on the display. The engineering system also has a test interface for the output of the changed output-end process data to a controller and for forwarding it to the addressable input/output units, which have a data connection to the controller. The test interface is furthermore designed for the input of input-end process data, which can be acquired by the controller from addressable input/output units which have a data connection to said controller, at least when the controller is in the test mode.

Furthermore, the invention relates to a programmer for a controller, especially for a programmable logic controller of a technical plant and/or of an automation system. The programmer has a display for the graphical output of process data of interconnected automation components, such as controllers, terminals, machines, input/output units and similar. It includes user input means for the input of user instructions and also programming software, which runs on a processor of the programmer, for the conversion of the input user instructions at least for the request and change of process data of selected input/output units on the display. The programmer has a test interface for the output of changed output-end process data to the controller and for forwarding to addressable input/output units, which have a data connection to the controller, The test interface is furthermore designed for the input of input-end process data, which can be acquired by the controller from addressable input/output units which have a data connection to said controller, at least when the controller is in the test mode.

Finally, the invention relates to an electronic display unit for circuit diagrams, which can be connected to a controller, especially to a programmable logic controller. A unit of this kind has a display for the graphical output of a circuit diagram and a user input means for the input of user instructions. Furthermore, the display unit has a test interface used for loading logic operations of input terminal points, which are at least partially interconnected, and/or output terminal points of input/output units which have a data connection to the controller, and/or equipment software, which runs on a processor of the display unit, for the graphical conversion of the logic operations into a circuit diagram display.

### BACKGROUND OF INVENTION

The digital input/output units can be designed for the input-end acquisition of digital switching states at their respective terminal points. They especially convert the D.C. voltage present at said terminals into a corresponding digital process value, which is then preferably output via a bus, e.g. a Profibus, which is connected to the input/output unit. Typically, the digital output value is interpreted by logic “1” or logic “0”. The maximum input D.C. voltages can, for example, be 24 V, 36 V, 48 V, 72 V. Alternatively, or in addition, the digital input/output units can be designed for the conversion of an A.C. voltage, such as 230 V, present at the input terminal points.

Alternatively, or in addition, the input/output units can be designed for the output of a digital process value, which preferably is received from the connected bus. In this case, a relay contact or an electronic switching element at a respective terminal point can be opened or closed corresponding to the associated received logic process value.

The input/output units under consideration can be designed for mounting on a top-hat rail or for plugging into a control unit. Typically, such input/output units have a series of input terminal points and/or a series of output terminal points, e.g. eight. The input/output units can be fitted in a switchgear cabinet together with a programmable logic controller and also with other automation components. Furthermore, the input/output units can be decentralized within a system, a system part or a production line. Normally, a higher level programmable logic controller (PLC) or a process computer is connected via a bus system with the respective input/output units for the transmission of process data.

The known input/output units typically each have an LED as a visual display means for a terminal point. A respective illuminated LED indicates that the switch contact of the adjacent assigned output terminal point has received an input signal causing it to close, Correspondingly, a respective illuminated LED at an adjacent assigned input terminal point indicates that a switching voltage is present at said input terminal point which corresponds to a logic “1”.

If a controller with a plurality of input/output units connected thereto is brought into operation or re-parameterized, or if an existing fault is rectified, the problem arises that the “logic” terminal point, considered in a wiring diagram of the complete controller, must first be time-consumingly located in the real physical world of a plurality of terminals and assemblies.

To solve the problem, it is known to allow the relevant LED at a terminal point of the sought input/output unit to illuminate by using the test means of the controller, in order to thus locate the input point and the correct terminal point. This is, of course, only possible if all other LEDs are also in the other switching state. If this is not possible, the complete system has to be moved to “stop” and the test means of the controller used to apply an individual activating input to the input and output terminal points and therefore to the respective LEDs.

### SUMMARY OF INVENTION

It is therefore an object of the invention to provide a digital input/output unit which does not have the aforementioned limitations.

Further objects of the invention are to provide a controller and an engineering system, a programmer for the controller and an electronic display unit suitable for this purpose.

The objects of the invention are achieved by a digital input/output unit, a suitable controller which can have a data connection to at least one input/output unit, a suitable engineering system for a controller, a suitable programmer for a controller and a suitable electronic display unit for circuit diagrams as claimed in the claims.

The electronic circuit has an evaluation means for the terminal point related signaling data received from the interface, in order to activate a respective selected visual display means regardless of the current switching state. Alternatively, or in addition, the electronic circuit can have evaluation means for the complete signaling data for the complete input/output unit, which is received from the interface, in order to provide a common control input to all the visual display means regardless of the particular current switching state.

This has the respective associated advantage that a visual display means, especially an LED can be activated to illuminate or not illuminate regardless of the current switching state of the terminal point associated with the display means. This means that the sought “physical” terminal point can be easily and quickly determined from a multiplicity of other terminal points of an input/output unit and especially that the correct input/output unit can be determined from a multiplicity of other input/output units connected to each other within a system.

“Terminal point related” in this context means the spatial proximity of the visual display means to the associated terminal point. The signaling data are especially binary coded. Thus, for example, an 8-bit wide signaling data output can be used individually to control eight LEDs, which are assigned to eight output terminal points of the input/output unit. In a corresponding manner, an 8-bit wide input signaling datum can be used for eight input terminal points. In principle, a single bit for coding the complete signaling data is adequate to control all LEDs of an input/output unit.

According to a particularly advantageous embodiment, the respective display means can be activated to cause it to flash, e.g. with a frequency of 1 to 5 Hz. This makes the display means particularly noticeable. Alternatively, or in addition, the visual display means can be controlled to produce a different color, e.g. illuminate red, if the display means for indicating the switching states are normally controlled to indicate green. This is possible in a particularly simple manner by means of a so-called DUOLED, which can be controlled to illuminate red or green, or red or yellow, as required.

According to a further embodiment, the input/output unit has means for the output of an acoustic signal if signaling data are received or a common signaling datum is received. Due to this, an even faster location of the relevant input/output unit is advantageously possible.

Advantageously, the interface is a bus interface. It is especially a parallel or serial cable-connected bus interface, such as a LAN or CAN bus interface. In principle, any bus interface type is conceivable for data transmission of the signaling data from the higher level controller to the respective addressed input/output unit. Instead of a digital transmission of the signaling data in the form of data words, the request for signaling to an input/output unit can also take place in analog form, for example by means of a current-loop signal or suitable modulation techniques.

Alternative, or in addition, the interface can be a wireless interface in accordance with a further embodiment, such as a WLAN interface.

The object of the invention is also achieved by means of a controller, particularly a programmable logic controller (PLC). Alternative, the controller can be a process computer or a connected assembly of a decentralized input/output unit. The controller has means for controlling terminal point related signaling data and/or receiving a common signaling datum for at least one digital input/output unit from the engineering system or from the programmer. Furthermore, the controller has means for forwarding the signaling data and/or the common signaling datum to the respective input/output unit connected to the communication bus. The means for receiving, for processing and forwarding the signaling data are preferably realized by means of an electronic control unit, especially by means of a microprocessor.

In this way, input and output terminal points, selected at the user end, of the respective input/output units can be visualized on the controller path, by means of the engineering system connected to the controller or by means of the programmer.

According to a particularly advantageous embodiment of the invention, the respective signaling data received from the engineering system or from the programmer and/or the received common signaling datum can be output when the plant is running or in automatic mode, to the respective addressed input/output units. Due to this, a plant or an automated system does not have to be brought to a “stop”, in order, for example, to find interconnection or wiring faults by means of the selected visualization, without having to change the associated switching state of the relevant terminal point during operation.

Furthermore, the object of the invention is achieved by an engineering system with a planning software, which is designed to output to the display graphic selection objects, which can be selected by the user. The selection objects are assigned to input terminal points and/or output terminal points of the respective input/output unit. Furthermore, a visual display means, assigned to the respective terminal point, of an addressed digital input/output unit, can be controlled when selecting a graphic selection object, in that corresponding signaling data from the engineering system can be output, via an controller connected thereto, to the respective input/output unit. Preferably, a same type of interface is used for the test interface and the bus interface.

In this way, a visualization of the input/output units to be wired or to be interconnected is easily achieved even during the planning of a plant. In the simplest case, a checkbox, as it is called, is assigned during the graphical output of the process data to an assigned logic terminal point as a selection object, which can be selected by means of a mouse, in order to control the associated LED at the physical input/output unit, e.g. to cause it to flash. The checkbox can e.g. also be shown grayed out in order to indicate to the user that this cannot be selected if the input/output unit to be connected cannot be accessed for data purposes or is not connected to the communication bus at all. Correspondingly, a common checkbox for one input/output unit in each case can be indicated on the display of the engineering system as a possible choice, if all the visual display means of an input/output unit are, for example, to be activated to flash.

Furthermore, the object of the invention is achieved by a programmer for a controller with programmable software, which is designed similarly to the planning software of the engineering system. Compared to the engineering system, the programmer is essentially limited to loading software modules into the controller and performing changes to the configuration or parameters of the controller.

According to an advantageous embodiment of the engineering system and of the programmer, the respective software is designed to output further user-selectable graphic selection objects to the display, which in each case are assigned to all the terminal points of the respective input/output unit. It is then possible, if a further graphic selection object is selected, to jointly control all the visual display units of a respective addressed digital input/output unit regardless of the particular current switching state, in that a corresponding common signaling datum is output by the engineering system or programmer to the respective input/output unit via the controller connected thereto.

Finally the object of the invention is achieved by means of an electronic display unit for circuit diagrams. The equipment software is designed so that input terminal points and/or output terminal points of the respective input/output unit shown on the display, and/or common connecting lines of input terminal points and/or output terminal points of the respective input/output units shown on the display can be individually selected by the user. Furthermore, the equipment software is designed so that after selection of at least one visual display means of a respective addressed digital input/output unit assigned to the respective terminal point or respective terminal points it can be controlled regardless of its current switching state. For this purpose, suitable signaling data are output by the display unit to the respective input/output unit via the controller connected thereto.

The electronic display unit is, for example, a notebook, a PDA or an operator/viewing device, such as an operator panel. A mouse, a keyboard or a touch screen can be used as the user input means. At the simplest, the user can click on the terminal points or the connecting lines using the mouse. In this way, it is advantageously possible that by clicking on a terminal point, graphically displayed in the circuit diagram, the associated LED of the digital input/output unit is activated to flash. If on the other hand a connecting line which connects several terminal points to each other is clicked on, all the associated terminal points can be activated to flash. The terminal points can also be assigned to different input/output units. In a real environment, e.g. of a plant, the latter can be installed at different locations. This enables the user, for example a fitter or service engineer, to advantageously and easily see which terminal points belong together.

### BRIEF DESCRIPTION OF THE DRAWINGS

The invention and advantageous embodiments of the invention are described in more detail with the aid of the following drawings. The drawings are as follows:

FIG. 1 an engineering system connected to a controller, and, as an example, an input/output unit connected via a communication bus,

FIG. 2 an example of an electronic circuit of an input/output unit for the individual visualization of an input terminal point,

FIG. 3 an example of an electronic circuit of an input/output unit for the individual visualization of an output terminal point.

### DETAILED DESCRIPTION OF INVENTION

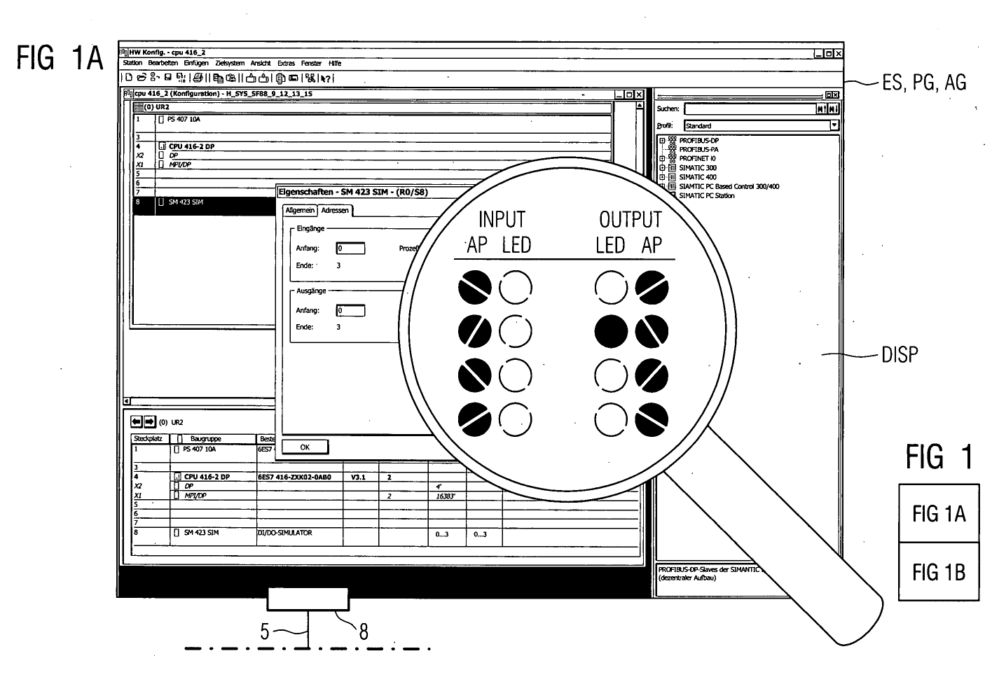

FIG. 1 shows an engineering system ES connected to a controller 3 and, as an example, an input/output unit 1 connected via a communication bus 6.

The engineering system ES is typically a personal computer on which a suitable planning software is running for the planning of a technical plant or automation system. Instead of the engineering system ES, a programmer PG can also be connected as an alternative. A display, such as a screen, for graphical output is designated by DISP. It serves for the display of process data IN, OUT, of logic operations and/or of interconnecting diagrams of automation components, which are to be connected to each other or are already connected. In the latter case, it is, for example, controllers 3, 3′ (PLC), terminals, machines, input and output units 1 and similar. The engineering system ES typically has a keyboard and a mouse for the input of user instructions, in order mainly to request or change the process data IN, OUT. The engineering system ES also has a test interface 8 for connecting the engineering system ES to the controller 3 via a communication bus 5. By means of the test interface 8, the changed output-end process data OUT can then be output to the controller 3, which then outputs this, for example to the only one addressable input/output unit 1 with a data connection. In the reverse direction, input-end process data IN from the respective input/output units 1 connected to the controller 3 can be acquired.

The magnifying glass shown in FIG. 1 is used to enable a better understanding of graphic input and output terminal points, shortened to “AP”, which are based on the external shape of input/output unit 1. Input-end terminal points are designated as “INPUT” and output-end terminal points are designated as “OUTPUT”. Normally, the process data IN, OUT, which correspond to the respective switching states of the respective input/output unit 1 at the respective terminal point E1-E4, A1-A4, are shown in the form of numerical values such as “0” or “1”.

In the central area of FIG. 1, a programmable logic controller 3 (PLC) is shown, which has a bus interface 7 for a (further) communication bus 6 for the input and output of process data IN, OUT which, for example, has only one connected addressed input/output unit 1. A plurality of input/output units 1 of that kind can be connected to such a communication bus 6. As also shown in FIG. 1, an input/output unit 1 can also be an integral part of a controller 3′, i.e. a controller 3′ with an integrated digital input/output unit 1. This is indicated by a box shown by dashes.

An input/output unit 1 is shown in the bottom part of FIG. 1. It has an interface 2 for connecting the input/output unit 1 to the communication bus 6. Furthermore, an input/output unit 1 of this kind has an electronic circuit 4 or control element electronics which convert the process data IN, OUT into corresponding switching signals IN′, OUT′ at the terminal points E1-E4, A1-A4 and vice versa. If the input/output unit 1 is designed for the output of process data OUT in the sense of an output unit, the electronic circuit 4 can be a circuit board with electronic components mounted thereon. This converts the input-end process data OUT originating from the communication bus 6 into a corresponding digital signal, which in turn activates a switching contact on the particular output terminal point A1-A4 for the output of the corresponding switching signal OUT′. If the input/output unit 1 is alternatively, or in addition, designed for the input of process data IN in the sense of an input unit, the electronic circuit 4 can be a circuit board with electronic components mounted thereon. This converts a particular input-end switching signal IN′ into a corresponding digital signal by means of a comparator, with the digital signal then being converted at the bus end into the input-end process data IN. The electronic components can also be combined in an integrated circuit, such as in a microcontroller.

Terminal points E1-E4, A1-A4 are preferably connecting terminals for connecting sensor and control lines. Preferably, the terminal points E1-E4, A1-A4 are each assigned a visual display means LED for display of the respective switching state. In the example in FIG. 1, exactly one (LED)(light emitting diode) is assigned to one terminal point E1-E4, A1-A4. An illuminated LED is indicated by ON and a non-illuminated dark LED is designated by OFF.

The electronic circuit 4 has an evaluation means for the terminal point related signaling data SIG, which is received from the interface 2, in order to activate particular selected visual display means LED regardless of the current switching state. Alternatively, or in addition, the electronic circuit 4 can have evaluation means for a common signaling datum ALL, which can be received from the interface 2, relative to the complete input/output unit in order to be able to jointly activate all visual display means LED regardless of the particular current switching state.

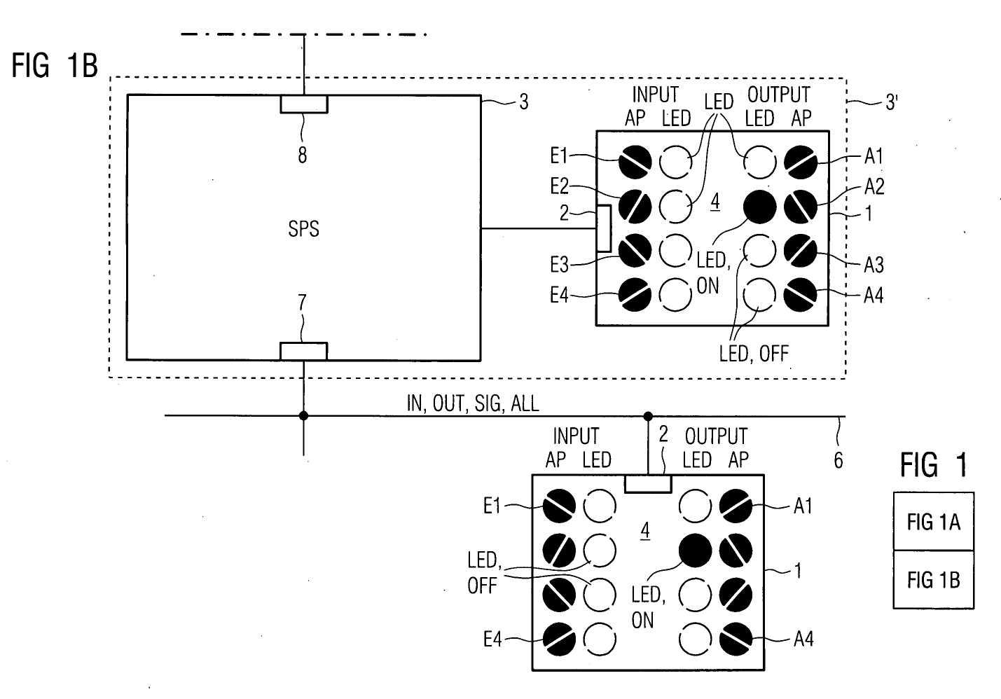

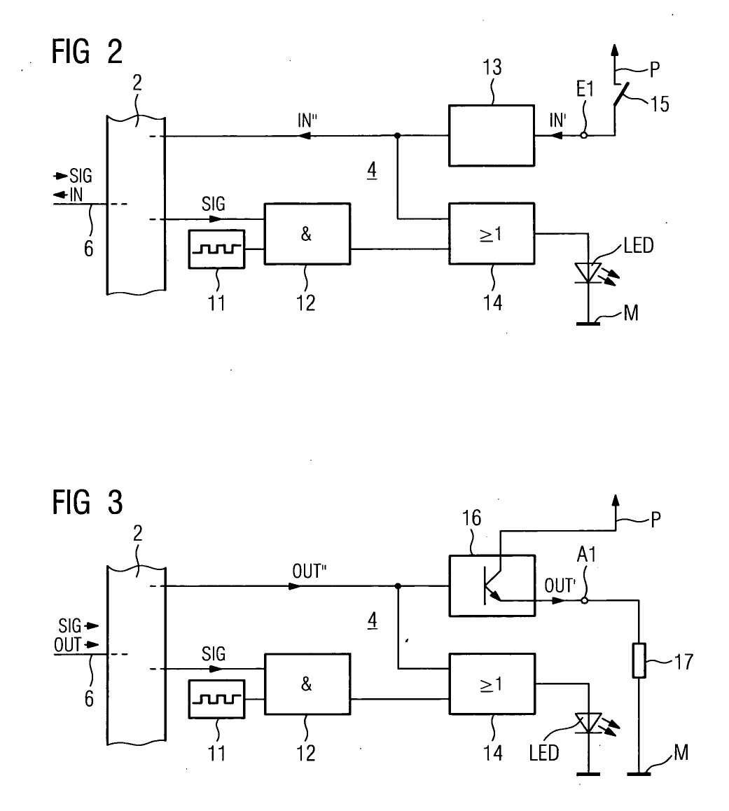

The conversion of process data IN, OUT to the respective switching signal IN′, OUT′ is explained in more detail using the following FIGS. 2 and 3 as examples.

FIG. 2 shows an example of an electronic circuit 4 of an input/output 1 unit for the individual visualization of an input terminal point 1. A section of the interface 2 can be seen in the left part of FIG. 2. It serves inter alia for the conversion of a digital signal IN″ to a corresponding processed input datum IN, which is then output at the bus end on the communication bus 6. The digital signal IN″ originates from an input element 13, especially from a comparator, which converts the switching signal IN′ present at the indicated input terminal point E1 into the digital signal IN″. The input element 13 is preferably an optocoupler for the electrically isolated acquisition of the switching signal IN′. A switch, such as a limit switch of a system, connected to the power supply P is designated as 15. Both switching states of the switch 15 can be acquired by the input/output unit 1 and forwarded to the controller 3 via the communication bus 6. The reference designator 14 designates an OR element, which inter alia receives the digital signal IN″. If this then has the value “1” when the switch 15 is closed, the light emitting diode LED for visualizing this switching state is activated to illuminate. Common ground is indicated by M.

If a valid signaling datum SIG for this input terminal point E1 is now received via the communication bus 6, this is output from the interface 2 in the form of a digital signal to an AND element 12. The other input of the AND element 12 is connected to a pulse generator 11 or a multivibrator. This generates a flashing frequency, e.g. in the 1 to 5 Hz range. This flashing frequency is applied to the remaining input of the OR element 14. In other words, the light emitting diode LED is activated to flash if there is a valid signaling datum SIG, regardless of the switching state IN′ of the input terminal point E1.

FIG. 3 shows an example of an electronic circuit 4 of an input/output unit 1 for the individual visualization of an output terminal point A1. The independent activation of the light emitting diode LED takes place in a similar manner to that shown in FIG. 2.

The left part of FIG. 3 again shows a section of the interface 2. It serves inter alia to convert an output-end process output datum OUT, originating from the communication bus 6, to a corresponding digital signal OUT″. This controls an output element 16, which converts, electrically isolated for example, the digital signal OUT″ into the output-end switching signal OUT′. To do this, the output element 16 closes an internal electronic switching contact, so that the indicated load can be switched via this switching contact to the power supply P.

1.-11. (canceled)

12. A digital input/output unit, comprising:
a series of terminal points;
visual display devices, one visual display device assigned to each one of the terminal points for display of a respective switching state;
a controller;
an interface for an exchange of process data with the controller;
an electronic circuit connected between the interface and the respective terminal points for conversion of the process data into corresponding switching signals and vice versa, wherein the electronic circuit has a first evaluation device for terminal point related signaling data received from the interface in order to activate a particular selected visual display device regardless of the current switching state.

13. The digital input/output unit as claimed in claim 12, wherein the electronic circuit has a second evaluation device for the common signaling datum relative to the complete input/output unit received from the interface in order to jointly activate all the visual display devices regardless of the particular current switching state.

14. The digital input/output unit as claimed in claim 12, wherein the terminal points are input terminal points.

15. The digital input/output unit as claimed in claim 12, wherein the terminal points are output terminal points.

16. The digital input/output unit as claimed in claim 12, wherein the input/output unit is for automation and plant engineering.

17. The digital input/output unit as claimed in claim 12, wherein the respective display devices are activated to flash.

18. The digital input/output unit as claimed in claim 12, further comprising:
an acoustic signal output device for outputting a signal when signaling data or a received common signaling datum are received.

19. The digital input/output unit as claimed in claim 12, wherein the interface is a parallel or serial bus interface.

20. The digital input/output unit as claimed in claim 12, wherein the interface is a wire-connected or wireless interface.

21. A controller, comprising:
a bus interface for a communication bus for an input and an output of process data to an addressed input/output unit connected to the communication bus such that the process data are converted into corresponding switching signals at terminal points of the input/output unit and vice versa;
a test interface for connecting the controller to an engineering system or to a programmer;
devices for acquiring output-end process data changed in the engineering system or by the programmer at an user end; and
devices for an output of the changed output-end process data to the addressed input/output unit, at least in a test mode of the controller, wherein the controller receives terminal point related signaling data and/or receives a common signaling datum for the digital input/output unit from the engineering system or from the programmer, and wherein the controller forwards the signaling data and/or the common signaling datum to the input/output unit connected to the communication bus.

22. The controller as claimed in claim 21, wherein the terminal points are input terminal points.

23. The controller as claimed in claim 21, wherein the terminal points are output terminal points.

24. The controller as claimed in claim 21, wherein the controller is a programmable logic controller.

25. The controller as claimed in claim 21, wherein the signaling data received from the engineering system or from the programmer and/or the received respective common signaling datum are output to the address input/output unit.

26. An engineering system, comprising:
a display for a graphical output of process data of logic operations and/or of interconnection drawings of automation components to be connected to each other or already connected to each other, such as controllers, terminals, machines, input and output units;
an user input device for the input of user instructions;
planning software, running on a processor of the engineering system, for the conversion of input user instructions at least when requesting, changing and displaying process data of selected input/output units on the display; and
a test interface for an output of changed output-end process data to a controller and for forwarding to addressable input/output units which have a data connection to the controller and for an input of input-end process data acquired by the controller from the addressable input/output units which have a data connection to said controller, at least when the controller is in a test mode,
wherein the planning software is designed to output to the display user-selectable graphic selection objects assigned to terminal points of the respective input/output unit, so that when a graphic selection object is selected a visual display means LED of an addressed digital input/output unit is activated regardless of its current switching state, in that corresponding signaling data are output from the engineering system to the respective input/output unit via a controller connected to it.

27. The engineering system as claimed in claim 26, wherein the terminal points are input terminal points.

28. The engineering system as claimed in claim 26, wherein the terminal points are output terminal points.

29. The engineering system as claimed in claim 26, wherein the software is designed to output user-selectable other graphic selection objects to the display, which in each case are assigned to all the terminal points of the respective input/output unit, so that when another graphic selection object is selected all visual display means of a respective addressed digital input/output unit are jointly activated regardless of the particular current switching state, in that a corresponding common signaling datum is output from the engineering system or programmer connected to it, to the respective input/output unit.

30. The engineering system as claimed in claim 26, wherein the engineering system is for planning a part of a technical plant.

31. The engineering system as claimed in claim 26, wherein the engineering system is for planning an automation system.
